(19) United States
(12) Patent Application Publication
(10) Pub. No.: US 2026/0296275 A1
(43) Pub. Date: Oct. 1, 2026

(54) Seat Bench for a Vehicle, and Vehicle

(71) Applicant: Bayerische Motoren Werke Aktiengesellschaft, Muenchen (DE)

(72) Inventors: Jens DEMPEWOLFF, Muenchen (DE); Joel Hedlund, Olching (DE); Michael Leng, Geltendorf (DE)

(21) Appl. No.: 19/634,243

(22) Filed: Mar. 31, 2026

(30) Foreign Application Priority Data
Apr. 1, 2025 (DE) 10 2025 112 629.1

(51) Int. Cl. B60N 2/433; B60N 2/30; B60N 2/36

(52) U.S. Cl. CPC B60N 2/433; B60N 2/3009; B60N 2/366

(57) ABSTRACT

A seating apparatus includes a seat bench having at least two seats, with a backrest which has a backrest part associated with a first of the seats as a first rest part and a second rest part which is pivoted relative to the first rest part between at least one sitting position and at least one transport position. The seating apparatus also includes a first locking element, a spring, and a securing element. The securing element, due to its mass inertia, in the event of a deceleration of the vehicle occurring at least in the longitudinal direction of the vehicle, is movable from a securing position securing the first locking element against the spring force in the locking position into a release position that allows a movement of the first locking element from the locking position into the stowed position.

### CROSS REFERENCE TO RELATED APPLICATION

This application claims priority under 35 U.S.C. §119 from German Patent Application No. 10 2025 112 629.1, filed Apr. 1, 2025, the entire disclosure of which is herein expressly incorporated by reference.

### BACKGROUND AND SUMMARY

The disclosure relates to a seat bench for a vehicle. Furthermore, the disclosure relates to a vehicle having at least one such seat bench.

DE 962 574 C discloses a vehicle seat with a foldable backrest. EP 0 697 307 A2 discloses a device for locking split folding backrests on motor vehicle rear seats, which are held in the normal position by means of associated locking devices on a vehicle body. Moreover, DE 199 19 562 A1 discloses a backrest support for a vehicle seat.

An object of the present disclosure is to provide a seat bench for a vehicle and a vehicle with at least one such seat bench, so that a particularly advantageous usability of the seat bench can be achieved.

This and other objects are achieved according to the disclosure by a seat bench having the features disclosed herein ,and by a vehicle having the features disclosed herein. Advantageous refinements of the disclosure are the subject matter of the present disclosure.

A first aspect of the disclosure relates to a seat bench for a vehicle, preferably a motor vehicle, in particular a motor car and, more particularly, a passenger car, the interior of which, also referred to as a passenger compartment, passenger cell or cabin, is formed by a structure designed, for example, as a self-supporting body. When fully manufactured, the vehicle has the structure, the seat bench, and the interior in which the seat bench is arranged. The seat bench has at least two seats arranged next to each other in the transverse direction of the vehicle when the seat bench is installed, namely a first seat and a second seat. The seat bench assumes its installation position in the fully manufactured state of the vehicle having the seat bench. The seat bench has a backrest which has at least or exactly one backrest part. The backrest part is also referred to as the first backrest part. When mention is made above and below to the backrest part, it is to be understood to mean the first backrest part, unless stated otherwise. The backrest part is a first rest part of the backrest. The backrest part is assigned to the first seat, wherein the backrest part forms the first seat in such a way or thereby that the backrest part forms a first back area of the first seat. A person sitting on the first seat can lean their back, in particular in the longitudinal direction of the vehicle, against the first back area and thus against the backrest part. For example, the seat bench has a first seat part assigned to the first seat, which partially forms the first seat in such a way that the first seat part forms a first seat area of the first seat. The person sitting in the first seat can sit with their buttocks on the first seat area and thus on the first seat part and support their buttocks downwards in the vehicle height direction of the vehicle on the first seat part.

The seat bench has a second rest part which can be pivoted relative to the first rest part between at least one sitting position and at least one transport position, in particular about a pivot axis which, for example, runs in the transverse direction of the vehicle when the seat bench is installed. At least in the sitting position, the second rest part is arranged next to the first rest part (backrest part) in the transverse direction of the vehicle. In particular, it is conceivable that the second rest part can be pivoted relative to the first rest part in the longitudinal direction of the vehicle, in particular about the pivot axis, and can thus be pivoted from the sitting position into the transport position, so that, for example, the second rest part is folded forward or folded down in the transport position relative to the sitting position in the longitudinal direction of the vehicle. In other words, the second rest part can preferably be folded or tipped forward about the pivot axis and in the longitudinal direction of the vehicle, and can thus be pivoted about the pivot axis from the sitting position into the transport position.

It is possible that, in a first variant of the seat bench, the seat bench has exactly two seats arranged next to each other in the installation position of the seat bench in the transverse direction of the vehicle, namely the first seat and the second seat. In a first sub-variant of the first variant, for example, the second rest part is a second backrest part, which is provided in addition to the first rest part and which is assigned to the second seat and thereby or in such a way partially forms the second seat that the second rest part as a second backrest part forms a second back area of the second seat. A person sitting on the second seat can lean their back in the sitting position of the second rest part, in particular in the longitudinal direction of the vehicle, backwards against the second back area and thus against the second backrest part, thereby leaning against and thus supporting themselves on the second rest part, i.e. the second backrest part.

In a second sub-variant of the first variant, which differs from the first sub-variant, the backrest has a third rest part in addition to the first rest part (backrest part) and in addition to the second rest part, which third rest part is a second backrest part. The second rest part can be pivoted relative to the first rest part and relative to the third rest part, in particular about the pivot axis, between the transport position and the sitting position. The third rest part is assigned to the second seat as a second backrest part, wherein the third rest part partially forms the second seat in such a way that the third rest part forms a second back area as described above, so that the person sitting on the second seat can lean their back, in particular in the longitudinal direction of the vehicle, against the second backrest part, and thus against the third rest part, and thus lean back and thus support themselves. In the second sub-variant, it is possible, in particular, for the second rest part to be arranged between the first rest part and the third rest part in the transverse direction of the vehicle, at least in the sitting position.

In a second variant of the seat bench, which differs from the first variant and thus from the first sub-variant and the second sub-variant, the seat bench has at least or exactly three seats arranged next to each other in the installation position of the seat bench in the transverse direction of the vehicle, namely the first seat, the second seat, and a third seat. In both the first variant and thus in the first sub-variant and the second sub-variant, as well as in the second variant, the first backrest part and preferably also the first seat part are assigned to the first seat as described above, so that here the first backrest part and the first seat part each partially form the first seat.

In the second variant, the second rest part is a second backrest part which is assigned to the second seat and partially forms the second seat in such a way or thereby that the second rest part forms a second back area of the second seat as a second backrest part. A person sitting on the second seat can lean their back in the sitting position of the second rest part, in particular in the longitudinal direction of the vehicle, backwards against the second back area and thus against the second rest part, thereby leaning against it and thus supporting themselves. The backrest has a third rest part in addition to the first backrest part (first rest part) and in addition to the second rest part (second backrest part), which third rest part is a third backrest part of the backrest. The third rest part is assigned to the third seat as the third backrest part and forms part of the third seat in such a way that the third backrest part (third rest part) forms a third backrest area of the third seat. A person sitting on the third seat can lean their back, in particular in the longitudinal direction of the vehicle, backwards against or onto the third back area and thus against or onto the third rest part, thereby leaning against it and thus supporting themselves. In particular, the second rest part is arranged between the first rest part and the third rest part, at least in the sitting position in the transverse direction of the vehicle. In particular, the second rest part can be pivoted about the pivot axis relative to the first rest part and relative to the third rest part.

In the first variant, and thus in the first sub-variant and in the second sub-variant, and also in the third variant, for example, the seat bench has a second seat part assigned to the second seat, which forms the second seat in part in such a way that the second seat part forms a second seating area of the second seat. The person sitting in the second seat can sit with their buttocks on the second seating area and thus on the second seat part, so that the person sitting in the second seat can support their buttocks in the vertical direction of the vehicle downwards on the second seating area and thus on the second seat part. For example, in the second variant, a third seat part is assigned to the third seat, which partially forms the third seat in such a way that the third seat part forms a third seating area of the third seat. The person sitting on the third seat can sit with their buttocks on the third seat area, and thus on the third seat part, in such a way that the person sitting on the third seat can rest their buttocks downwards in the longitudinal direction of the vehicle on the third seat area, and thus on the third seat part.

It is conceivable that the vehicle has at least or exactly three rows of seats arranged consecutively in the longitudinal direction of the vehicle and thus one behind the other, namely a first row of seats, a second row of seats, and a third row of seats. The second row of seats is connected to the first row of seats at the rear in the longitudinal direction of the vehicle and is thus arranged behind the first row of seats in the longitudinal direction of the vehicle. The third row of seats adjoins the first row of seats and the second row of seats at the rear in the longitudinal direction of the vehicle and is thus arranged behind both the first row of seats and the second row of seats in the longitudinal direction of the vehicle, so that the second row of seats is arranged between the first row of seats and the second row of seats in the longitudinal direction of the vehicle. The second row of seats is or comprises the seat bench, which is thus, for example, a rear seat. During a journey in the vehicle, persons such as the driver of the vehicle may be present in the aforementioned interior of the vehicle.

For example, when the vehicle is in its fully assembled state, a luggage compartment of the vehicle, also referred to as a trunk, adjoins the seat bench at the rear in the longitudinal direction of the vehicle, in which luggage such as travel luggage can be transported. For example, at least in the sitting position of the second rest part, the luggage compartment is bounded in the longitudinal direction of the vehicle towards the front, in particular at least or exclusively, partially and preferably directly by a rear side of the second rest part, the rear side of which faces towards the rear in the longitudinal direction of the vehicle in the sitting position. Since, for example, the second rest part is folded forward or folded down in the transport position relative to the sitting position in the longitudinal direction of the vehicle, the rear side of the second rest part, for example, faces upward in the transport position in the vertical direction of the vehicle. Thus, for example, in the transport position, a through-loading facility, also known as a loading pass-through, is created, with the aid of which even long objects such as skis can be transported. This makes it possible for a very long object in the transport position of the second rest part to extend partially into the luggage compartment and to extend from the luggage compartment in the longitudinal direction of the vehicle at least over part of the rear side, and thus to be partially arranged on the rear side of the second rest part in the transport position, so that even such long objects can be transported in the vehicle.

The seat bench also has a locking device by means of which the second rest part can be locked in the sitting position relative to the first rest part and, in particular, to the first rest part. This means that when the second rest part is locked in the sitting position relative to the first rest part and, in particular, to the first rest part by means of the locking device, any movement of the second rest part relative to the first rest part from the sitting position to the transport position, which is particularly undesirable, is prevented by means of the locking device.

In particular, the second rest part can be pivoted relative to the first rest part and also relative to the third rest part between the transport position and the sitting position, especially about the pivot axis.

The locking device has a first locking element arranged on the first rest part, which is, for example, a bolt or is also referred to as a bolt. The bolt is also referred to as a locking bolt or locking pin. Furthermore, the locking device has a second locking element arranged on the second rest part and thus movable with the second rest part relative to the first rest part and, in particular, also relative to the first locking element between the sitting position and the transport position.

The second locking element is designed to interact with the first locking element in the sitting position of the second rest part, in particular in a form-fitting manner, whereby the second rest part can be locked or is locked in the sitting position relative to the first rest part. In other words, in the sitting position, the second locking element can interact with the first locking element, in particular in a form-fitting manner, or in the sitting position, the second locking element interacts with the first locking element, in particular in a form-fitting manner, whereby the second rest part is lockable or locked in the sitting position relative to the first rest part.

In order to achieve particularly advantageous usability of the seat bench and thus of the vehicle as a whole, the disclosure provides that the first locking element is held on the first rest part in such a way that it can be moved, in particular pivoted, from a locking position into a stowed position relative to the first rest part and, for example, also relative to the second rest part. In the locking position, the first locking element is further away from the first rest part than in the stowed position, in particular in the installation position of the seat bench in the transverse direction of the vehicle. For example, the first locking element is held on the first rest part in such a way that it can be moved, in particular pivoted, relative to the first rest part and, for example, also relative to the second rest part between the stowed position and the locking position. Thus, for example, when the second rest part is in the transport position, the first locking element can be moved, in particular pivoted, relative to the first rest

part and preferably also relative to the second rest part from the locking position into the stowed position. In particular, for example, when the second rest part is in the transport position, the first locking element can be moved, in particular pivoted, relative to the first rest part and preferably also relative to the second rest part between the stowed position and the locking position. For example, it may be provided that the first locking element protrudes into an effective area in the locking position, in which the second locking element interacts or can interact with the first locking element, in particular in a form-fitting manner, in the sitting position of the second rest part, thereby locking the second rest part relative to the first rest part in the sitting position, i.e. to secure it, wherein, for example, the effective area is arranged in the installation position of the seat bench in the transverse direction of the vehicle next to the first rest part, in particular viewed towards the third rest part. Thus, for example, at least a partial area of the first locking element is arranged in the aforementioned effective area in the locking position. It is preferably provided that, in the stowed position, the partial area of the first locking element is arranged outside the effective area, in particular completely. In particular, it is provided that in the stowed position, the entire first locking element is arranged outside the effective area. In particular, it is provided that in the stowed position, the first locking element does not protrude from the first rest part in the transverse direction of the vehicle and, for example, towards the third backrest part, so that it is preferably provided that in the stowed position of the first locking element, the first locking element does not protrude from the first rest part in the transverse direction of the vehicle. In the locking position, the second locking element can be brought into, in particular, form-fitting cooperation with the first locking element, i.e., it can be moved, by moving the second rest part from the transport position into the sitting position. In particular, it is provided that the first locking element is held movably on the first rest part from the locking position to the stowed position, in particular between the locking position and the stowed position, completely bypassing the second rest

part, so that, for example, the second rest part can be pivoted between the transport position and the sitting position relative to the first rest part and relative to the first locking element, while the first locking element is either in the locking position or in the stowed position and, in particular, the first locking element does not move.

The first locking element is assigned a spring element, which is also referred to as the first spring element. When reference is made above and below to the spring element, it is to be understood to mean the first spring element, unless otherwise stated. The first spring element is preferably designed as a solid body and thus as a mechanical spring. At least in the locking position of the first locking element, the spring element provides a spring force acting at least indirectly, in particular directly, from the first spring element on the first locking element, which is also referred to as the first spring force. Where mention is made above and below to the spring force, it should be understood as meaning the first spring force, unless stated otherwise. By means of the spring force, the first locking element can be moved from the locking position into the stowed position, in particular pivoted.

According to the disclosure, a securing element is also provided, in particular in addition to the first locking element, which, due to its mass inertia, also referred to simply as inertia, in the event of a deceleration of the vehicle, at least in the longitudinal direction of the vehicle and caused, for example, by an accident, can be moved, in particular pivoted, from a securing position securing the first locking element in the locking position against the spring force into a release position permitting, i.e., releasing, a movement of the first locking element from the locking position into the stowed position, which movement is caused or can be caused by the spring force. In other words, in the securing position, the securing element prevents a movement of the first locking element from the locking position into the stowed position, which movement is caused or movable by the spring force, by securing, i.e., holding, the first locking element in the locking position against the spring force in the locking position by means of the

securing element, in particular in a form-fitting manner. In the release position, however, the securing element allows movement of the first locking element from the locking position to the stowed position, which movement can be caused or is caused by the spring force. In other words, in the release position, the securing element allows a movement of the first locking element out of the locking position and into the stowed position, which movement can be caused or is caused by the spring force. In this case, the securing element can be moved from the securing position to the release position solely on the basis of its mass inertia due to the aforementioned deceleration occurring at least or exclusively in the longitudinal direction of the vehicle. This means in particular the following: The aforementioned deceleration is, for example, an acceleration of the vehicle and thus of the securing element, at least or exclusively in the longitudinal direction of the vehicle, in particular a negative acceleration, wherein this acceleration decelerates the vehicle in the longitudinal direction of the vehicle. This means that the acceleration, and thus the deceleration, at least reduces or eliminates the speed at which the vehicle is moving forward in the longitudinal direction of the vehicle, i.e., reduces it to zero, wherein this acceleration moves the securing element from the sitting position to the release position due to the mass inertia of the securing element. The aforementioned deceleration, i.e., the aforementioned acceleration, may be caused, for example, by an accident, i.e., result from a collision of the vehicle, which, for example, collides in the longitudinal direction of the vehicle with an object located in front of the vehicle in the longitudinal direction of the vehicle and outside the vehicle. The aforementioned acceleration is, for example, at least or exactly 2g. For example, the acceleration is greater than 2g. For example, the acceleration is exactly 3g or greater than 3g. In other words, it is preferably provided that the seat bench is designed, in particular with regard to the mass inertia of the securing element, in such a way that the securing element, due to its mass inertia and thus independently, moves from the securing position to the release position when and preferably only when the aforementioned deceleration or

acceleration exceeds a threshold value that is greater than zero, wherein the threshold value is preferably, in particular at least, 2g. Most preferably, the threshold value is greater than 2g. Most preferably, the threshold value is, in particular, at least 3g. This prevents undesirable movement of the securing element from the securing position to the release position, for example as a result of the vehicle braking, and it can be ensured that the securing element moves, for example due to its mass inertia and thus independently, from the securing position to the release position when and preferably only when an accident occurs involving the vehicle such that the acceleration acting on the vehicle and thus on the securing element, or its value, is greater than the threshold value.

In the locking position, the first locking element enables the second rest part to be securely and firmly locked in the sitting position. If the first locking element is in the stowed position, so that, compared to the locking position, the first locking element does not protrude or protrudes less far from the first rest part, particularly in the transverse direction of the vehicle, especially while the second rest part is in the transport position, particularly high vehicle safety can be achieved, since, for example, it can be prevented that a person sitting in or on the third row of seats comes into contact with the first locking element as a result of, for example, an accident and, in particular, as a result of the aforementioned acceleration and the resulting forward movement of this person in the longitudinal direction of the vehicle and thus in the direction of the second row of seats. The disclosure thus enables a particularly high level of safety and thus a particularly advantageous usability of the seat bench, in a particularly space-saving, weight-saving, and cost-effective manner, since, for example, additional drive elements and/or actuators for moving the securing element from the securing position to the release position and for moving the locking element from the locking position to the stowed position can be avoided.

Since the securing element moves, in particular solely, from the securing position to the release position due to its mass inertia and thus, in particular, solely independently, especially when the acceleration exceeds the threshold value, and since the first locking element can then be moved or is moved from the locking position to the stowed position solely by means of spring force, additional actuators and/or connecting elements that are space-consuming, weight-intensive, and costly for moving the first locking element and the securing element can be avoided, so that a particularly high level of safety and a particularly high, advantageous usability of the seat bench can be achieved in a space-saving, weight-saving, and cost-effective manner. When mention is made above and below to the locking element, it is to be understood to mean the first locking element, unless stated otherwise.

In order to achieve particularly good usability of the seat bench in a particularly space-saving, weight-saving, and cost-effective manner, one embodiment of the disclosure provides that the seat bench, also referred to as the seating system, and in particular the vehicle as a whole, is free of a mechanical forced coupling which couples the first locking element to the second rest part mechanically, i.e., via a solid body, a liquid or a gas, such that movement of the second rest part from the sitting position to the transport position causes movement of the first locking element from the locking position to the stowed position. This allows the number of parts, weight, and cost of the seat bench to be kept particularly low, and the first locking element can be moved from the locking position to the stowed position as required, particularly in the event of an accident. This avoids the need for complex, costly, and space-consuming mechanical positive couplings, in which the first locking element is mechanically coupled to the second backrest part in such a way that movement of the second rest part between the transport position and the sitting position causes movement of the first locking element between the locking position and the stowed position.

A further embodiment is distinguished in that the first locking element can be pivoted from the locking position to the stowed position, in particular between the locking position and the stowed position, about a first pivot axis relative to the first rest part and is thereby movable, in particular held on the first rest part. The securing element can be pivoted about a second pivot axis extending obliquely or perpendicularly to the first pivot axis from the securing position into the release position, in particular relative to the first rest part, and can thus be moved. This allows for particularly easy movement or movability of the first locking element and the securing element. The feature that the pivot axes run at an angle or perpendicular to each other is to be understood as follows: The first pivot axis runs along an imaginary first straight line and is perpendicular to an imaginary first axis plane. The second pivot axis runs along a second imaginary straight line and perpendicular to a second imaginary axis plane. The axis planes run at an angle or perpendicular to each other.

In order to achieve particularly advantageous usability of the seat bench, a further embodiment of the disclosure provides for a second spring element to be assigned to the securing element. Preferably, the second spring element is designed as a solid body and thus as a mechanical spring. At least in the securing position, the second spring element provides a second spring force acting at least indirectly, in particular directly, from the second spring element on the securing element, by means of which the securing element is held or is to be held in the securing position. This means that the second spring force opposes or counteracts any movement of the securing element from the securing position to the release position, so that, for example, when the securing element is moved from the securing position to the release position, the second spring element must be loaded, in particular further, in particular tensioned or compressed, and/or the second spring force must be increased. This can, for example, prevent the securing element from undesirably moving from the securing position to the release position due to its mass inertia during such initial decelerations or initial accelerations of the motor vehicle, the initial decelerations or initial accelerations of which are less than or equal to the aforementioned threshold value. In particular, the spring element can be designed or specified in such a way that the securing element moves from the securing position to the release position solely due to its mass inertia and thus, in particular, purely independently and preferably only then moves from the securing position to the release position when a second acceleration or second deceleration of the motor vehicle that is greater than the respective initial deceleration or initial acceleration exceeds the threshold value. The characteristic that the acceleration exceeds the threshold value means, in particular, that an absolute value of the acceleration, designated as an absolute amount or amount, exceeds the threshold value, which is greater than zero and thus positive.

In order to achieve a particularly high level of safety and thus a particularly advantageous usability of the seat bench, a further embodiment of the disclosure provides for a blocking element, preferably designed as a solid body and most preferably self-rigid, in addition to the securing element and also in addition to the first locking element, by means of which a movement of the first locking element, which is in the stowed position, from the stowed position into the locking position, in particular in a form-fitting manner, is prevented or can be prevented. This can prevent, for example, the first locking element from moving undesirably from the stowed position into the locking position after the first locking element has been moved from the locking position into the stowed position by means of the spring force.

In a further, particularly advantageous embodiment of the disclosure, it is provided that the blocking element prevents movement of the first locking element, which is in the stowed position, from the stowed position into the locking position, in particular in a form-fitting manner, by the first locking element in the stowed position being at least partially overlapped by the blocking element in a blocking direction that is opposite to a direction of movement in which the first locking element can be moved from the locking position into the stowed position. This reliably prevents the first locking element in the stowed position from moving undesirably from the stowed position into the locking position, thereby achieving a particularly high level of safety. In particular, the aforementioned direction of movement is or comprises a movement path along which the first locking element can be moved from the locking position into the stowed position. The blocking direction coincides with the movement path and/or the blocking direction is or comprises a blocking path that coincides with the movement path. In particular, the movement path may be curved, in particular circular.

In a further, particularly advantageous embodiment of the disclosure, the blocking element is movable relative to the first locking element located in the stowed position and relative to the first rest part between at least one blocking position and at least one release position. In the blocking position, movement of the first locking element, which is in the stowed position, from the stowed position into the locking position is prevented by the blocking element. In the release position, the blocking element allows movement of the first locking element in the stowed position from the stowed position to the locking position. This allows the first locking element to be blocked as required and thus particularly advantageously.

A further embodiment is distinguished in that the blocking element can be moved, i.e., moved in a translational manner, relative to the first locking element between the blocking position and the stowed position along an axis of movement running in particular along an imaginary straight line. This allows the first locking element to be secured in the stowed position in a particularly advantageous manner, so that a particularly high level of safety can be achieved.

In order to advantageously allow movement of the first locking element from the locking position to the stowed position and, in particular, to prevent undesirable movement of the first locking element from the stowed position to the locking position, a further embodiment of the disclosure provides that the blocking element, in particular at its free end, has an actuating surface which runs in an imaginary plane inclined to the axis of movement. When moving from the locking position to the stowed position, the first locking element slides, in particular directly, along the actuating surface, whereby the first locking element, when moving from the locking position to the stowed position, displaces the blocking element along the axis of movement from the blocking position to the release position.

A second aspect of the disclosure relates to a vehicle, which is preferably in the form of a motor vehicle, very preferably a motor car, and in particular a passenger car, in the interior of which there is arranged at least one seat bench according to the first aspect of the disclosure. Advantages and advantageous refinements of the first aspect of the disclosure can be considered to be advantages and advantageous refinements of the second aspect of the disclosure, and vice versa.

Further details of the disclosure emerge from the description below of a preferred exemplary embodiment with the associated drawings, in which:

Other objects, advantages and novel features of the present disclosure will become apparent from the following detailed description of one or more preferred embodiments when considered in conjunction with the accompanying drawings, in which:

### BRIEF DESCRIPTION OF THE DRAWINGS

FIG. 1 is a schematic rear view of a seat bench of a vehicle; and

FIG. 2 is a further schematic rear view of a detail of the seat bench; and

FIG. 3 is a schematic representation of a locking device of the seat bench; and

FIG. 4 is a further schematic representation of a detail of the locking device.

### DETAILED DESCRIPTION OF THE DRAWINGS

In the figures, identical or functionally identical elements are provided with the same reference signs.

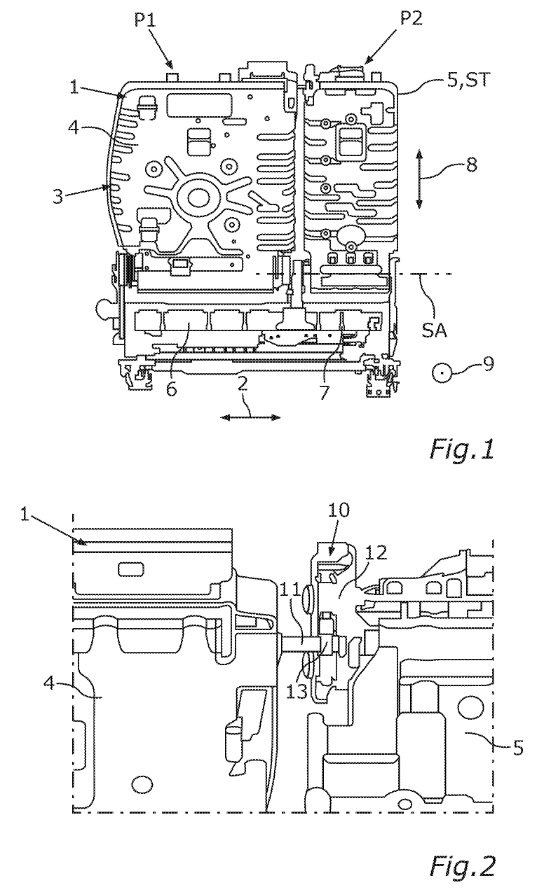

FIG. 1 shows a schematic rear view of a seat bench 1 of a vehicle, wherein a detail of the seat bench 1 is shown in a further schematic rear view in FIG. 2. The seat bench 1 has at least or exactly two seats, namely a first seat P1 and a second seat P2. The seats P1 and P2 are arranged next to each other in the transverse direction of the vehicle when the seat bench 1 is in its installed position. FIG. 1 shows the installation position of the seat bench 1, which assumes its installation position when the vehicle comprising the seat bench 1 is in the fully raised state. The transverse direction of the vehicle is shown by a double arrow 2. The seat bench 1 has a backrest 3, which has a first rest part 4 assigned to the first seat P1. As will be explained in detail below, the first rest part 4 is a first backrest part. The backrest 3 has a second rest part 5, which in this case is a second backrest part. The rest part 4 is assigned to the first seat P1 and forms the first seat P1 in such a way or to such an extent that the rest part 4 forms a first back area of the first seat P1. The rest part 5, as the second backrest part, is assigned to the second seat P2 and forms the second seat P2 in such a way or partially in such a way that the rest part 5 forms a second back area of the second seat P2.

The seat bench 1 has a first seat part 6 and a second seat part 7. The seat part 6 is assigned to the seat P1 and forms the seat P1 in such a way that the seat part 6 forms a first seating area of the seat P1. The seat part 7 is assigned to the seat P2 and forms the seat P2 or part thereof in such a way that the seat part 7 forms a second seating area of the second seat P2. A person sitting in seat P1 can lean their back against the backrest 4 in the longitudinal direction of the vehicle and thus support themselves on the backrest 4. In addition, the person sitting on seat P1 can support their buttocks against seat part 6 in the vehicle height direction of the vehicle. The vehicle height direction of the vehicle is illustrated by a double arrow 8, runs in the vehicle transverse direction in the image plane of FIG. 1 and perpendicular to the vehicle transverse direction. The longitudinal direction of the vehicle is illustrated by a double arrow 9 and runs perpendicular to the image plane of FIG. 1 and thus perpendicular to the vertical direction of the vehicle and perpendicular to the transverse direction of the vehicle. A person sitting in seat P2 can lean their back backwards in the longitudinal direction of the vehicle against the backrest 5 and thus support themselves on the backrest 5, and the person sitting in seat P2 can also support their buttocks downwards in the vertical direction of the vehicle on the seat part 7.

The rest part 5 can be pivoted about a pivot axis SA running in the transverse direction of the vehicle relative to the backrest 4 and also relative to the seat parts 6 and 7 between a transport position not shown in the figures and a sitting position ST shown in FIGS. 1 and 2. By pivoting the rest part 5 from the sitting position ST to the transport position, the rest part 5 is or becomes pivoted forward in the longitudinal direction of the vehicle and thereby folded or folded down, i.e., folded onto the seat part 7 and thus folded onto the seat part 7.

A combined view of FIGS. 1-3 clearly shows that the seat bench 1 has a locking device 10 by means of which the rest part 5 can be locked relative to the rest part 4 and, in particular, to the rest part 4 in the sitting position ST, i.e., it can be fixed and thus secured. For this purpose, the locking device 10 has a lock 12 arranged on the backrest part 5 and thus pivotable with the backrest part 5 relative to the backrest part 4 and relative to the locking element 11, which lock has a lock latch 13. The lock latch 13 is a fork latch. The lock latch 13 is a second locking element of the locking device 10. The second locking element (locking latch 13) is designed to interact in a form-fitting manner with the first locking element 11 in the sitting position ST, whereby the second rest part 5 can be locked or is locked in the sitting position ST relative to the rest part 4 and in particular on the rest part 4.

In order to be able to realize a particularly advantageous use or usability of the seat bench 1 in a particularly advantageous manner, the first locking element 11 can be held on the first rest part 4 movably, in particular pivotably, from a locking position VS (FIG. 4) into a stowed position VST (FIG. 4) relative to the first rest part 4, wherein, for example, the first locking element 11 is held on the first rest part 4 movably, in particular pivotably, between the locking position VS and the stowed position VST. In the exemplary embodiment shown in the figures, the first locking element 11 is held on the rest part 4 so that it can be pivoted about a second pivot axis SA2 from the locking position VS into the stowed position VST, in particular between the locking position VS and the stowed position VST, relative to the rest part 4. In the locking position VS, the first locking element 11 in the installed position of the seat bench 1 is further away from the first rest part 4 in the transverse direction of the vehicle than in the stowed position VST, in particular in such a way that in the sitting position ST of the rest part 5 and in the locking position VS, the locking element 11 protrudes into an effective area in the transverse direction of the vehicle, so that in the sitting position ST of the second rest part 5 and in the locking position VS of the locking element 11, at least a partial area TB of the locking element 11 is arranged in the effective area designated WB. In the sitting position ST, the locking element 11, which is in the locking position VS, interacts in a form-fitting manner with the second locking element (lock latch 13) in the effective area WB, whereby the rest part 5 is locked in the sitting position ST, in particular in a form-fitting manner. In the stowed position VST, at least the partial area TB is arranged, in particular completely, outside the effective area WB. In the locking position VS, the second locking element can be brought into, in particular, form-fitting engagement with the first locking element 11 by moving the second rest part 5 from the transport position into the sitting position ST.

The seat bench 1, in particular the vehicle as a whole, is completely free of a mechanical forced coupling which mechanically couples the first locking element 11 to the second rest part 5 in such a way that a movement of the second rest part 5 from the sitting position ST into the transport position causes a movement of the first locking element 11 from the locking position VS into the stowed position VST.

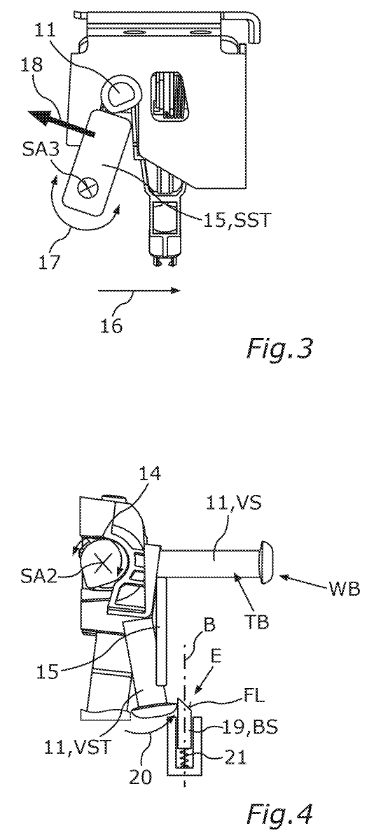

The first locking element 11 is assigned a first spring element 14, shown schematically in FIG. 4, which, at least in the locking position VS, provides a first spring force acting at least indirectly on the first locking element 11, by means of which the first locking element 11 can be moved from the locking position VS into the stowed position VST. In addition, a securing element 15 is assigned, which in this case is designed as a lever. Therefore, the securing element 15 is also referred to as a securing lever. Due to its mass inertia, the securing element 15, in the event of a deceleration of the vehicle, and thus of the securing element 15, occurring at least in the longitudinal direction of the vehicle, is movable from a securing position SST, which secures the first locking element 11 in the locking position VS against the first spring force, into a release position that allows a movement of the first locking element 11 from the locking position VS into the stowed position VST, which movement can be caused or is caused by the first spring force. In FIG. 3, an arrow 16 illustrates a direction of travel, also referred to as the forward driving direction or forward direction of travel, in which the vehicle travels or can travel forward in the longitudinal direction of the vehicle, in particular at a certain speed. The aforementioned deceleration is or comprises an acceleration which then acts on the vehicle and thus on the securing element 15 when the aforementioned speed at which the vehicle initially travels forward along the longitudinal direction of the vehicle is reduced and, for example, reduced to zero. This acceleration and thus the deceleration results, for example, from an accident involving the vehicle, which, for example, collides with its front end in the longitudinal direction of the vehicle against a barrier arranged in the longitudinal direction of the vehicle in front of the vehicle and outside the vehicle. This deceleration or acceleration, which is particularly abrupt and therefore strong, causes the securing element 15 to move, solely due to its mass inertia and therefore exclusively, independently from the securing position SST to the release position relative to the rest parts 4 and 5, in particular at least or exclusively when the rest part 5 is in the transport position. In the

release position, the spring element 14 can relax at least partially and thereby move the locking element 11 from the locking position VS to the stowed position VST, i.e., in this case, pivot about the pivot axis SA2 relative to the rest parts 4 and 5.

Preferably, the securing element 15 can be held movably, in particular pivotably, on the rest part 4 from the securing position SST into the release position relative to the rest part 4, in particular with complete bypassing of the rest part 5.

In the exemplary embodiment shown in the figures, the securing element 15 is held on the rest part 4 so that it can be pivoted about a third pivot axis SA3 from the securing position SST into the release position relative to the rest parts 4 and 5, with the pivot axes SA2 and SA3 running at an angle or perpendicular to each other. In the installed position of the seat bench 1, the pivot axis SA3 runs in the transverse direction of the vehicle, i.e., parallel to the transverse direction of the vehicle. The pivot axis SA2 runs, for example, in the longitudinal direction of the vehicle, i.e., parallel to the longitudinal direction of the vehicle.

The securing element 15 is assigned a second spring element 17, which is shown schematically in FIG. 3 and which, at least in the securing position SST, provides a second spring force acting at least indirectly on the securing element 15, as illustrated by an arrow 18, by means of which the securing element 15 is held or is to be held in the securing position SST. It can be seen that the second spring force opposes or counteracts a movement of the securing element 15 from the securing position SST to the release position. This prevents the securing element 15 from moving undesirably from the securing position SST to the release position and, for example, remaining in the securing position SST, in particular continuously, as long as the aforementioned deceleration or acceleration is less than or equal to a threshold value. In particular, it can be ensured that the securing element 15, due to its mass inertia, then and only then, in particular completely, moves independently from the securing position SST to the release position when the aforementioned deceleration or acceleration exceeds the threshold value, for example due to an accident. This can be adjusted accordingly by the second spring force and a mass of the securing element 15.

In the exemplary embodiment shown in the figures, a blocking element 19 is provided in addition to the securing element 15 and in addition to the locking element 11, by means of which a movement of the first locking element 11, which is in the stowed position VST, from the stowed position VST into the locking position VS is prevented or can be prevented. By means of the blocking element 19, movement of the first locking element 11, which is in the stowed position VST, from the stowed position VST into the locking position VS is prevented or can be prevented by the fact that the first locking element 11, which is in the stowed position VST, is at least partially overlapped by the blocking element 19 in a blocking direction illustrated by an arrow 20, which is opposite to a direction of movement in which the first locking element 11 can be moved from the locking position VS into the stowed position VST.

In the exemplary embodiment shown in the figures, the blocking element 19 is a slider which can be displaced relative to the first locking element 11 located in the stowed position VST and also relative to the rest parts 4 and 5 along an axis of movement B. In particular, the blocking element 19 is held on the rest part 4 so that it can be moved along the axis of movement B relative to the rest part 4, in particular with complete bypassing of the rest part 5. Along the axis of movement B, the blocking element 19 can be moved relative to the locking element 11 and also relative to the rest part 4 between a blocking position BS and a release position. In the blocking position BS, the movement of the first locking element 11, which is in the stowed position VST, from the stowed position VST to the locking position VS is prevented by the blocking element 19. In the release position, the blocking element 19 allows the first locking element 11, which is initially in the stowed position VST, to move from the stowed position VST to the locking position VS.

The blocking element 19 has an actuating surface FL at its free end E, which runs in an imaginary plane inclined to the axis of movement B. When the locking element 11 moves from the locking position VS to the stowed position VST, it slides directly along the actuating surface FL, thereby moving the blocking element 19 from the blocking position BS along the axis of movement B into the release position.

A third spring element 21 is assigned to the blocking element 19 and is designed as a solid body and thus as a mechanical spring. At least in the release position, the spring element 21 provides a third spring force acting at least indirectly, in particular directly, from the spring element 21 on the blocking element 19, by means of which the blocking element 19 can be displaced and is thus movable from the release position into the blocking position BS along the axis of movement B. Thus, the blocking element 19 can be moved from the blocking position BS into the release position against the third spring force.

During its movement from the locking position VS to the stowed position VST, the first locking element 11 slides along the actuating surface FL until the locking element 11 reaches the stowed position VST, in particular completely. As the locking element 11 slides down the actuating surface FL, the blocking element 19 is moved from the blocking position BS into the release position and, in particular, is prevented from returning to the blocking position BS. However, when the locking element 11 reaches the stowed position VST, the locking element 11 allows the spring element 21 to relax at least partially, whereby the locking element 11 allows the blocking element 19 to be moved from the release position into the blocking position BS by means of the third spring force and thus by means of the spring element 21.

In order, for example, to be able to reverse the locking element 11, i.e., to move it from the stowed position VST into the locking position VS, in particular to move it back, the blocking element 19 is moved, for example by a person, from the blocking position BS into the release position against the third spring force, whereupon, for example, the locking element 11, while the blocking element 19 is in the release position, can be moved, in particular moved back, against the first spring force, from the stowed position VST into the locking position VS. After the locking element 11 has reached the locking position VS and is in the locking position VS, the locking element 11 can be secured, in particular again, by means of the securing element 15, in particular against movement, in particular back, into the stowed position VST.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

### LIST OF REFERENCE SIGNS

1 seat bench

2 double arrow

3 backrest

4 first rest part

5 second rest part

6 first seat part

7 second seat part

8 double arrow

9 double arrow

10 locking device

11 first locking element

12 lock

13 lock latch

14 first spring element

15 securing element

16 arrow

17 second spring element

18 arrow

19 blocking element

20 arrow

21 third spring element

B axis of movement

BS blocking position

E end

P1 first seat

P2 second seat

ST sitting position

SA pivot axis

SA2 pivot axis

SA3 pivot axis

VS locking position

VST stowed position

SST securing position

FL actuating surface

TB partial area

WB effective area

What is claimed is:

1. A seating apparatus for a vehicle, comprising:
a seat bench having at least two seats, with a backrest which has a backrest part associated with a first of the seats as a first rest part and a second rest part which is pivoted relative to the first rest part between at least one sitting position and at least one transport position, and with a locking device which has a first locking element arranged on the first rest part and a second locking element, which is arranged on the second rest part and which is designed to interact with the first locking element in the sitting position, whereby the second rest part is lockable in the sitting position relative to the first rest part, wherein
the first locking element is movably held on the first rest part from a locking position to a stowed position relative to the first rest part and, in the locking position in which the second locking element is brought into cooperation with the first locking element, protrudes further from the first rest part than in the stowed position,
a spring element is assigned to the first locking element and provides a spring force at least in the locking position, via which the first locking element is movable from the locking position into the stowed position; and
a securing element is provided which, due to its mass inertia, in the event of a deceleration of the vehicle occurring at least in the longitudinal direction of the vehicle, is movable from a securing position securing the first locking element against the spring force in the locking position into a release position that allows a movement of the first locking element from the locking position into the stowed position, which movement is caused by the spring force.

2. The seating apparatus according to claim 1, wherein
the seat bench is free of a mechanical forced coupling which mechanically couples the first locking element to the second rest part in such a way that a movement of the second rest part from the sitting position to the transport position causes movement of the first locking element from the locking position to the stowed position.

3. The seating apparatus according to claim 1, wherein
the first locking element is pivotable from the locking position into the stowed position about a first pivot axis relative to the first rest part and is thus movable; and
the securing element is pivotable about a second pivot axis extending obliquely or perpendicularly to the first pivot axis from the securing position into the release position and is thus movable.

4. The seating apparatus according to claim 1, wherein
the securing element is assigned a second spring element which, at least in the securing position, provides a second spring force via which the securing element is held or is to be held in the securing position.

5. The seating apparatus according to claim 1, wherein
a blocking element provided in addition to the securing element, via which blocking element a movement of the first locking element located in the stowed position from the stowed position into the locking position is prevented.

6. The seating apparatus according to claim 5, wherein
the blocking element prevents movement of the first locking element, which is in the stowed position, from the stowed position into the locking position due to the first locking element, which is in the stowed position, being at least partially overlapped by the blocking element in a blocking direction that is opposite to a direction of movement in which the first locking element is movable from the locking position into the stowed position.

7. The seating apparatus according to claim 5, wherein
the blocking element is movable relative to the first locking element located in the stowed position and relative to the first rest par between:
i) at least one blocking position, in which movement of the first locking element located in the stowed position from the stowed position into the locking position is prevented by the blocking element; and
ii) a release position in which the blocking element allows movement of the first locking element located in the stowed position from the stowed position into the locking position.

8. The seating apparatus according to claim 7, wherein
the blocking element is displaceable along an axis of movement relative to the first locking element between the blocking position and the release position.

9. The seating apparatus according to claim 8, wherein
the blocking element has an actuating surface which runs in an imaginary plane inclined to the axis of movement, wherein the first locking element slides along the actuating surface when it moves from the locking position to the stowed position, thereby moving the blocking element from the blocking position to the release position.

10. A vehicle having an interior in which is arranged the seating apparatus according to claim 1.
